(19) United States
(12) Patent Application Publication
(10) Pub. No.: US 2013/0073413 A1
(43) Pub. Date: Mar. 21, 2013

(54) Automated Bidding Patience Tool

(71) Applicants: Kulvir Singh Bhogal, Austin, TX (US); Rick Allen Hamilton, II, Charlottesville, VA (US); James Robert Kozloski, Yorktown Heights, NY (US); Clifford Alan Pickover, Yorktown Heights, NY (US)

(72) Inventors: Kulvir Singh Bhogal, Austin, TX (US); Rick Allen Hamilton, II, Charlottesville, VA (US); James Robert Kozloski, Yorktown Heights, NY (US); Clifford Alan Pickover, Yorktown Heights, NY (US)

(73) Assignee: INTERNATIONAL BUSINESS MACHINES CORPORATION, Armonk, NY (US)

(21) Appl. No.: 13/473,871

(22) Filed: May 17, 2012

Related U.S. Application Data
(63) Continuation-in-part of application No. 13/238,367, filed on Sep. 21, 2011.

(51) Int. Cl. G06Q 30/02

(52) U.S. Cl. 705/26.3

(57) ABSTRACT

Frenzied bidding in an electronic auction is avoided or prevented by receiving by a proxy bidding agent computer one or more counter-bidding control parameters from a bidder console, wherein the counter-bidding control parameters identify an item to watch, counter-bid conditions, and counter-bid patience parameters; during an electronic auction, monitoring one or more conditions of an item in the auction while automatic counter-bidding is performed by the proxy bidding agent; during the monitoring detecting counter-bid conditions being unmet or violated; and responsive to the detecting, preventing counter-bidding by the proxy bidding agent.

### CROSS-REFERENCE TO RELATED APPLICATIONS

### Claiming Benefit Under 35 U.S.C. 120

This application is a continuation-in-part of application Ser. No. 13/238,367, our docket AUS920110308US1, filed on Sep. 21, 2011, by Kulvir S. Bhogal, et al.

### FEDERALLY SPONSORED RESEARCH AND DEVELOPMENT STATEMENT

None.

### MICROFICHE APPENDIX

Not applicable.

### INCORPORATION BY REFERENCE

None.

### FIELD OF THE INVENTION

The invention generally relates to tools and utilities for automatically placing a bid in an electronic auction for an item being offered via the auction.

### BACKGROUND OF INVENTION

FIG. 6 shows a generalization of the well-known arrangement (600) of components for an electronic or online auction. Generally, one or more computer networks (601) interconnect at least one offeror's console with typically a plurality of bidder's consoles, and one or more auction server computers (602). The offeror's console may be a variety of computer devices, such as a personal computer (desktop, laptop, notebook, etc.), a tablet computer, or a smart cellular telephone phone (e.g. Apple iPhone™, Google Android™ phone, Research in Motion Blackberry™, etc.). The bidder's console(s) may take the same various forms as the offeror's console. The auction server may also be of one of these forms of computer devices, and alternatively it may be a more powerful “server” class of machine, such as an enterprise server, blade server, etc., running a much more capable operating system, such as IBM's AIX™, or a variant of UNIX™. Additionally, the auction server may be a conglomeration of hardware and software assets dynamically tasked to achieve the logical results of an auction server, such as an on-demand computing environment, a “cloud” computing environment, and a grid computing environment. The interconnecting computer networks may include one or more suitable data and voice communications networks, such as the Internet, an intranet, a virtual private network, a wireless network, a local area network, a wide area network, a telephone network, a radio link, and an optical link.

To place an item “up for auction”, a bidder console is used to create and upload certain digital assets regarding the offered item, as well as one or more offering parameters, to the auction server. The digital assets might include one or more digital photographs, one or more video clips, and one or more textual descriptions of the item. The offering parameters may include identification information regarding the offering party (e.g. name, address, email address, web site address, telephone number, ratings or rankings for previously auctioned items, etc.), as well as parameters regarding the price (and optionally quantity) of the item(s) being offered (e.g. minimum bid, maximum bid a.k.a. “buy it now” price, auction opening time and date, and auction closing time and date).

The auction server receives and stores the digital assets for the item in a database (608), for later retrieval and transmission to the bidder consoles during the auction. The auction server receives and stores the offering parameters and implements those in a profile for the auction associated with the offeror's account.

After the auction opening time and date, and prior to the auction's closing time and date, the auction server then interacts with the bidder's consoles to provide the digital assets for the item being offered, as well as to provide any bid status information (e.g. minimum bid, maximum bid, current bid, time left to close, etc.) to a bidding party. The auction server receives from the bidder console(s) one or more bids containing bid parameters (e.g. bid or offer-to-buy value, optionally with quantity indicator). The auction server then processes each received bid according to one or more auction schema (e.g. straight auction, Dutch auction, reverse auction, etc.), and updates the bid status and auction status for the item being offered. For example, if a bid is below the minimum bid offering parameter, the bid may be rejected. If a bid is above the minimum bid offering parameter and bests the current bid level, the bid may be accepted and the current bid level updated to reflect the best bid. If the bid meets or exceeds the maximum bid, the auction may be closed and the item may be marked as sold. When the auction closing time and date arrives, the auction may be closed and the current bid declared the “winner”. And, if a bid is received after the auction closing time and date, the bid may be rejected.

Ultimately, the auction is concluded with or without the item being sold. If no bids above the minimum bid offering parameter are received, then the auction may close without a winner or purchaser. If the auction is concluded during active bidding upon the expiration of the auction “window”, then the best bid is selected, where “best” may be the highest monetary value bid, or may be a combination of monetary bid value and quantity bid (in the situation of multiple items being available). For example, an airline offering seats on a particular flight route may accept a lower “dollar per seat” bid value if the bidder is offering to purchase a superior quantity of seats.

Upon the conclusion of the auction, with or without a successful sale being consummated, the auction server may archive certain information, such as the digital assets for the offered item, the bid parameters (winning bid value and quantity), and auction results (identification of winning party(ies), etc.) into a historical sales database (609). This information is then used to facilitate billing of the bidding party, reimbursement of the offering party, and other administrative functions (auditing, accounting, marketing, etc.).

### SUMMARY OF EXEMPLARY EMBODIMENTS OF THE INVENTION

Frenzied bidding in an electronic auction is avoided or prevented by receiving by a proxy bidding agent computer one or more counter-bidding control parameters from a bidder console, wherein the counter-bidding control parameters identify an item to watch, counter-bid conditions, and counter-bid patience parameters; during an electronic auction, monitoring one or more conditions of an item in the auction while automatic counter-bidding is performed by the proxy bidding agent; during the monitoring detecting counter-bid conditions being unmet or violated; and responsive to the detecting, preventing counter-bidding by the proxy bidding agent.

### BRIEF DESCRIPTION OF THE DRAWINGS

The description set forth herein is illustrated by the several drawings.

FIG. 1 provides an example embodiment of an improved arrangement of components of an online or electronic auctioning system according to at least one embodiment of the related invention in which proxy items are offered into the auction.

FIG. 2 depicts another example embodiment of an improved arrangement of components of an online or electronic auctioning system according to at least one embodiment of the related invention in which proxy items are offered into the auction, and in which proxy bids are made on the proxy items.

FIG. 3 illustrates a further embodiment according to the related invention in which market analysis services are integrated into the arrangement of components.

FIG. 4 provides an example logical process according to the related invention.

FIG. 5 sets forth a generalized architecture of computing platforms suitable for at least one embodiment of the present and the related inventions.

FIG. 6 illustrates a generalization of well-known components of an online or electronic auction system.

FIG. 7 provides an example embodiment of an improved arrangement of components of an online or electronic auctioning system according to at least one embodiment of the related invention.

FIG. 8 illustrates an improved arrangement of and the interactions between components of an auction system which allows bidders to use a proxy bidding agent to avoid overbidding during potential frenzy bidding.

### DETAILED DESCRIPTION OF EXEMPLARY EMBODIMENT(S) OF THE INVENTION

The inventors of the present and the related invention have recognized problems not yet recognized by those skilled in the relevant arts. In the related invention, the inventors realized that when an offering party, whether they be an individual person or a corporate entity, wishes to offer an item for sale in an online or electronic action, the offeror must first determine a reasonable set of offering parameters such as a minimum bid, the length of time to allow the auction to proceed, whether or not to offer a maximum “buy it now” bid option, and if so, what the maximum bid value should be. Usually, such potential offerors will do some sort of informal and incomplete review of similar items to determine a starting price, or, in the case of extremely valuable items, they may have a professional appraisal performed. However, for less valuable items, such time and expense is not warranted relative to the item's value, so they often take a best guess at these offering parameters.

The inventors recognized this problem and addressed it with the related invention to allow for an automated, thorough and well-grounded prediction of an item's auctionable value and pendency in the auction, which is described herein for better understanding of the present invention.

The inventors have also recognized another problem in the art, which is not yet recognized by others in the art, regarding bidder's patience in bidding. Some bidders naturally have the ability to “wait it out” for an auction, and not to become overly excited and bid in a manner which escalates the price and/or bidding pace. Many other bidders, however, tend to get caught up in the moment of the action of the auction, and will begin to counter-bid for an item in a counter-productive manner from the purchasers' perspectives (e.g. driving the price up too fast).

The inventors have recognized that there are several technical parameters which can be monitored in an electronic auction which can be used to throttle or hold back such an undisciplined bidder's actions on behalf of the bidder, to essentially provide “patience” in the bidder's actions, and to thereby allow the bidder not only to win more auctions, but also to do so at a lower final price. The present invention provides such a tool to the bidding user.

### Offeror's Tool (Related Invention)

Because of the complementary nature of the present invention to the related invention, and due to the enhanced understandability of the present invention in view of the related invention, we first review the related invention and its operation.

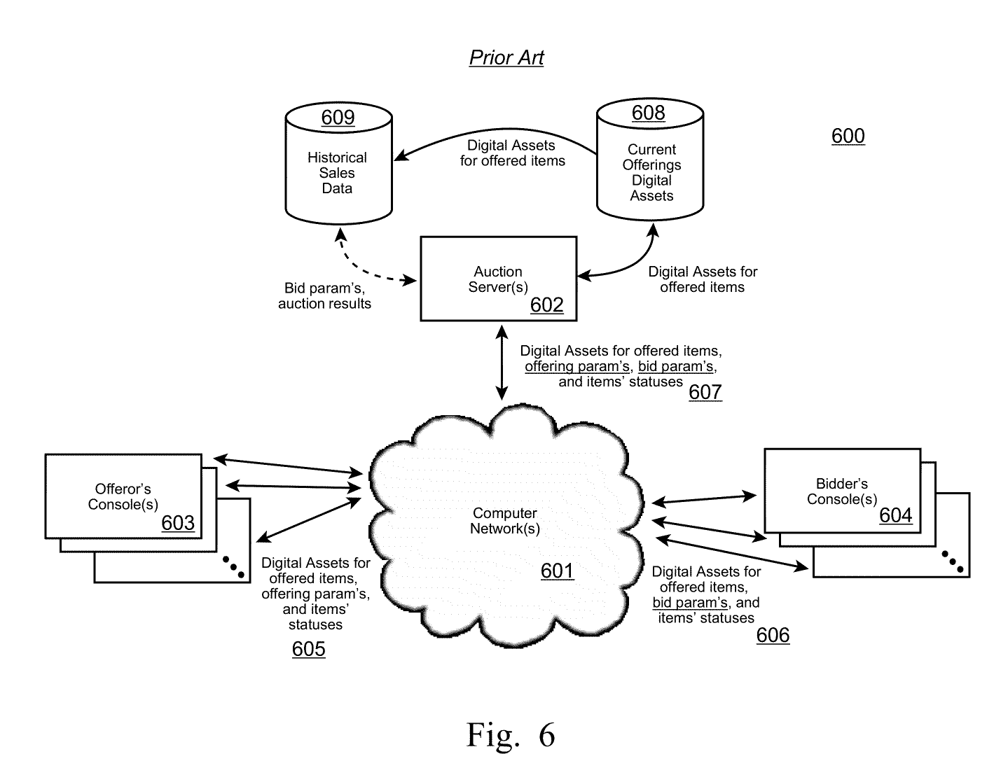

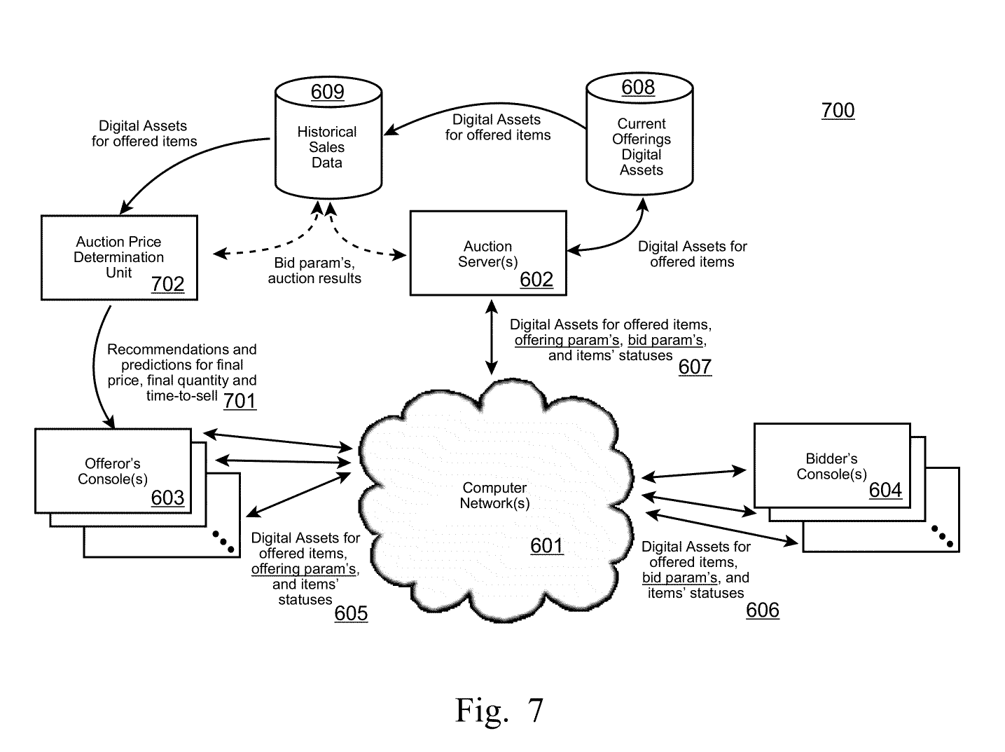

Turning to FIG. 7, an enhanced arrangement (700) of components for an online or electronic auction is shown according to at least one embodiment of the related invention, which in addition to the components of FIG. 6, adds an Auction Price Determination Unit (APDU) (702) which is communicably interfaced to the historical auction sales data (609) to receive digital assets (photos, descriptions, etc.) regarding items previously sold and unsold in the auction, bid parameters regarding results of previously concluded auctions (number of bids, length of time in auction until sale completed, pace of bids, values of bids, values of increments in the bids, etc.). The APDU is also communicably interfaced to the offeror's console (603) so as to propose potential offering parameters (minimum bids, maximum bids, length of auction, etc.). The communications interfaces between the APDU and the historical sales data and the offeror consoles can be any of the previously-described networks (601), and may also be through direct integration to the auction server (602), to the offeror console, or through a combination of direct integration with the auction server and offeror console. Such integration may be through providing one or both of the auction server and the offeror console with program code modifications or additions (C, C++, cobol, Java, Java Beans, etc.), extensions, plug-ins, helper applications, dynamic link libraries (DLLs), locatable objects (e.g. CORBA, etc.), and the like, all of which may be provided in tangible form through storing them on tangible, computer readable memory devices, or through loading them into a processor and executing them, or through a combination of storage, loading, and executing.

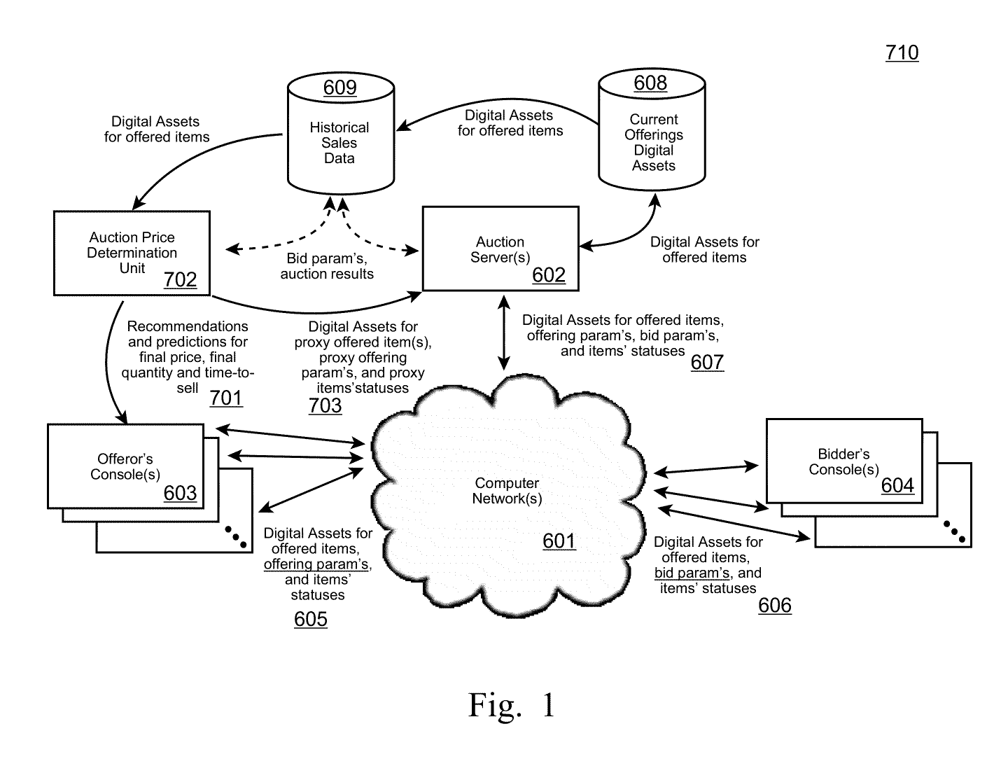

FIG. 1 illustrates another enhanced arrangement (701) of components according to at least one embodiment of the related invention of an online or electronic auction system, similar to those illustrated in FIGS. 6 and 7, with the further enhancement of the APDU (702) providing one or more proxy items (703) into the auction so as to create auction activity relevant to the task at hand as described in the following paragraphs. By “proxy”, we are referring to an item having a similar or the same description and optionally the same quantity as the real item which is to be offered in the auction. By offering such a substitute item into the auction and allowing a period of bidding to proceed on it, relevant information can be obtained about the likely bidding values and pattern that will occur with the real item is offered. The use of this technique is further described in more detail in the following paragraphs.

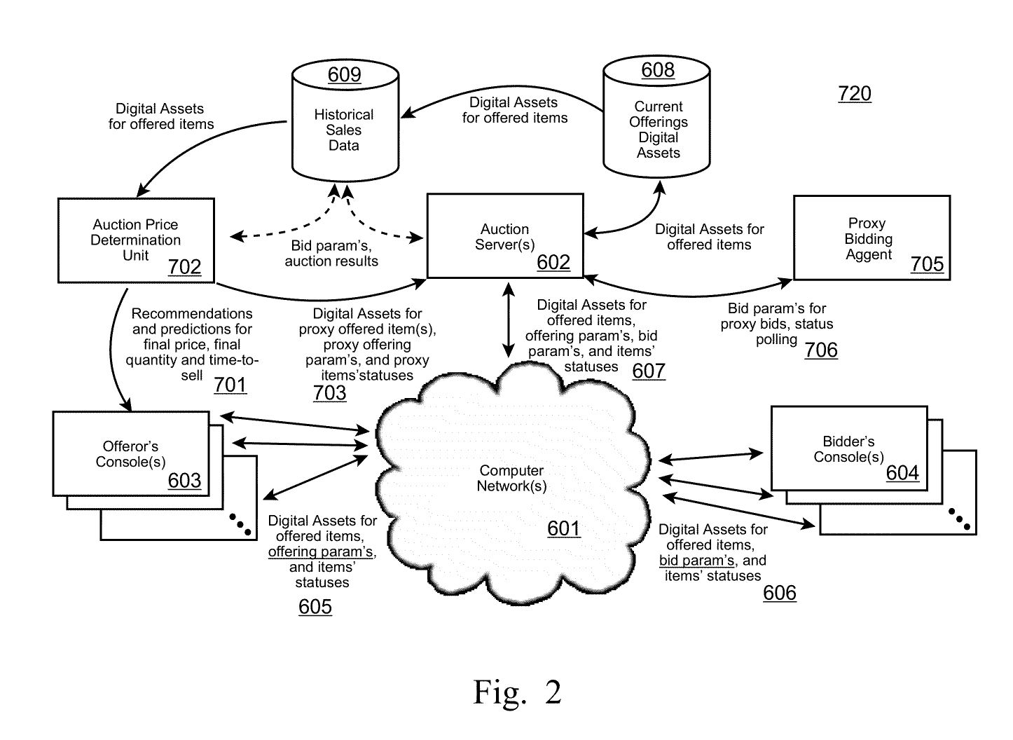

FIG. 2 also depicts an enhanced arrangement (720) according to at least one embodiment of the related invention, which, like the arrangement of FIG. 1, provides proxy items (703) in the auction server (602), but also provide a proxy bidding agent (705) which enters proxy bids (706) into the auction, details of the process for which will be described in subsequent paragraphs.

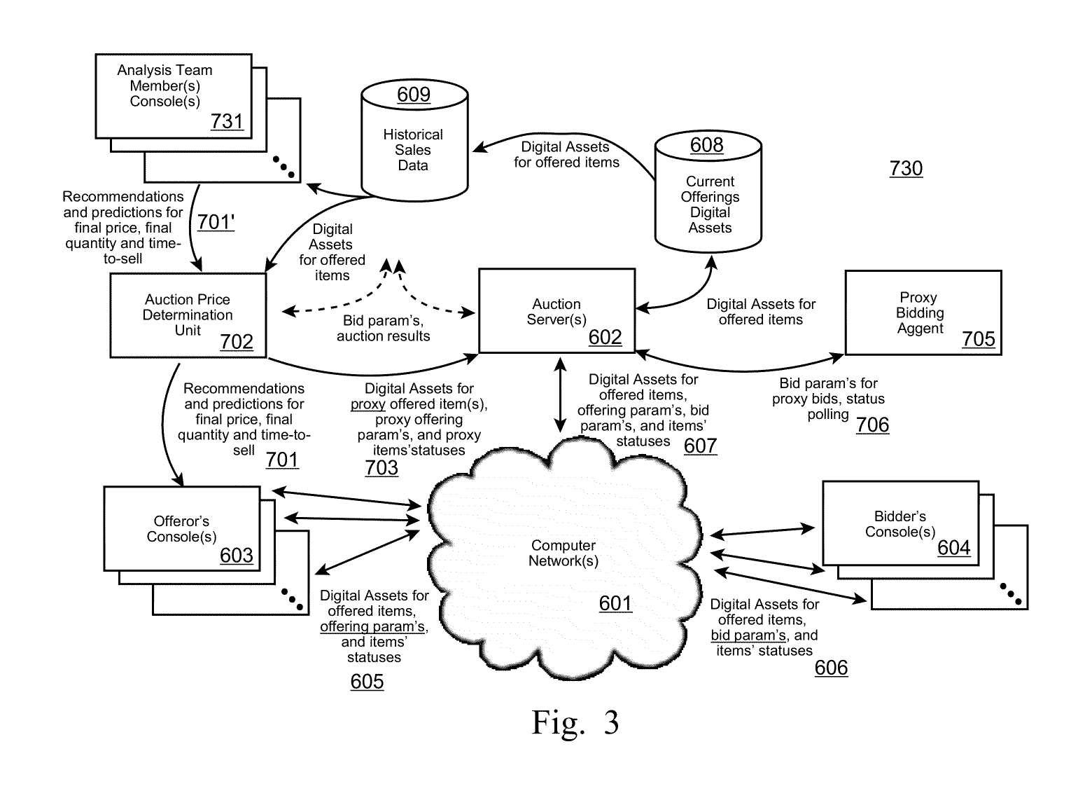

Turning to FIG. 3, a further enhanced embodiment and arrangement (730) of components according to the related invention is shown in which one or more analysis team member console(s) (731) are communicably interfaced to the APDU (702), and optionally to the historical sales database (609), so as to allow expert analysts to be consulted under certain conditions, and to allow the expert analysts to provide via the consoles (731) recommendations for the minimum bid, maximum bid and auction time window offeror parameters (701′).

Logical Process Examples.

The following paragraphs set forth example logical processes according to the related invention, which, when coupled with processing hardware, embody systems according to the related invention, and which, when coupled with tangible, computer readable memory devices, embody computer program products according to the related invention.

Embodiments of the related invention help an auction offering party (e.g. a user) to determine a relevant price for an item that he or she may wish to offer or sell an item in an electronic or online auction. Embodiments of the invention perform an initial analysis by scanning histories of sales of similar, related, complementary, or competitive items, or combination of two or more of these types of items, then automatically triggers additional market analysis services when a price suggestion has a high uncertainty level, i.e. when the certainty level of the suggested price is below a threshold value. In this manner, the offeror is more likely to obtain accurate pricing information.

Moreover, embodiments of the related invention may be realized as an enhancement to available online and electronic auction systems, which may include auction systems that provide users with suggested prices. Specifically, this related invention describes a means of enhancing such responses with automated queries to third party market analysis services, such as a team of analysts, under various conditions. The system also suggests optimal times to sell an item a well, as well as a plurality of probabilities of sale for a set of different possible offering prices (e.g. 90% for $5000 but 40% for $8000). The automatic market analysis service may include initiation of an automatic, computer controlled auction in which a similar “proxy” item (or items) is offered for an abbreviated time.

As previously mentioned, users of auction systems are often uncertain as to a reasonable price to ask for items to be auctioned or sold. For example, if a user (offeror) has a three-year-old computer hard drive to offer into an auction, should he attempt to obtain $20, $100, or $200 for the unit? Further, how long should he allow the auction window to be open? The answer to these questions will determine his set price if sold under traditional circumstances, or a minimum price if auctioned. Currently, this determination is typically done by the auction seller manually analyzing sales and posing as a buyer. This, of course, requires time invested on behalf of the seller, and, in some cases, may discourage would-be sellers from participating in auctions.

Additionally, users may wish to receive suggested prices with probabilities of sale for different periods of time. For example, a price of $20 may be associated with a 90% chance of sale during holiday times, while a price of $100 may be associated with a 50% chance on weekends, but a 60% chance on weekdays, based on empirical evidence.

Such estimates may be obtained by analyzing past sales; however, sometimes there will be insufficient information, and any suggested prices will be “uncertain.” Embodiments of the present invention overcome this uncertainty and provide a more certain answer.

Still further, users may want to know what the ideal price is for a ‘Buy It now’ type auction (e.g. maximum bid value) is that yields the least time to sell. For example, if one sells an item for $1 he will likely sell within 5 days, but if he sells the same item for $1.50, the sale will likely take 10 days. Note that the feature disclosed herein creates a “stickiness” for users of auction systems and services, such as eBay™, as well as non-auction listing services such as Craig's List™. If an auction service provides the functionality described herein, perhaps for a small fee, which may be managed by the service, more users will be likely to use this service (and continue to use this service because the system allows the users to determine reasonable asking prices and requires less research to be performed by a potential seller.

A typical user may have various degrees of knowledge about prices to ask for items for sale, such as antiques, computer equipment, or cleaning services, although such knowledge and needs may extended upward to expensive items like homes. One way to determine a reasonable asking price is for an auction service to mine past sales, then analyze and aggregate such information for a user. However, in some situations, the analyzing element may not have sufficient past data, and a means is needed to improve the suggested price delivered to a person who wishes to sell or auction an item.

So, embodiments of the related invention provide functionality for enhancing online auctions and listing services to provide for determining recommended prices by automatically triggering additional automatic market analysis services when a price suggestion has a high uncertainty level, i.e., when the certainty of the suggested price is below a threshold. For example, a user submits an item description for an item to sell. Alternatively, the user may be selling a service instead of a good, such as a house cleaning service.

The APDU (Auction Price Determination Unit) suggests a price based on a combination of several of the following elements in at least one embodiment:
1) A mining of price information of sales in the past for the same, similar, or complimentary items or services. Note the analysis might take into account condition of the item being sold.
2) A market analysis team component, automatically triggered when the certainty associated with a suggested price is low. This step may involve a signal sent to a marketing team who may charge a fee for such expertise and service.
3) A user profile that specifies information about the user (for example, does the user typically want a fast sale)
4) Automatic initiation of a short-term auction of a similar item, designed to probe auction markets by means similar to those employed by High Frequency Trading in financial markets.

The user profile in element 3 above may be stored on a user's computer, on a cloud, in a mobile device, etc. Such a user profile may contain financial information about a user, a level of risk and risk avoidance, a desire for fast sales, and other related parameters. A confidence (e.g. certainty) value is updated at regular intervals to indicate how sure the system is with respect to a response (a price). For example, after scanning databases of past sales, the system may request price estimates from more than one (human) market analysis team. Once such information is gained from teams, confidence values will likely increase. Note that such teams may charge small fees for such services. In practical operations, users may not seek many teams for low-price items but may be willing to use this system to probe one or more teams if the potential value of the item for sale is high.

Also, some teams may respond faster than others, and, in the interest of time, a user may specify desired timing. In one embodiment, multiple third party services may be employed to provide the aforementioned suggestion data. The third parties might be rated by people auctioning in terms of accuracy of their predictions when compared to the final price, quantities, and times at which actual items sold. Users who are auctioning may end up preferring one suggestion service over another, similar to user preference for Rotten Tomatoes™ versus Internet Movie Database (IMDB)™, for movie ratings. Suggestion services may be ranked according to industry expertise as well. For example, “Suggestion Service A” might prove to be accurate predictors of technology items, whereas they might be less capable in predicting prices for sports memorabilia. “Suggestion Service B” on the other hand may be a better predictor for sports memorabilia as opposed to technology item pricing.

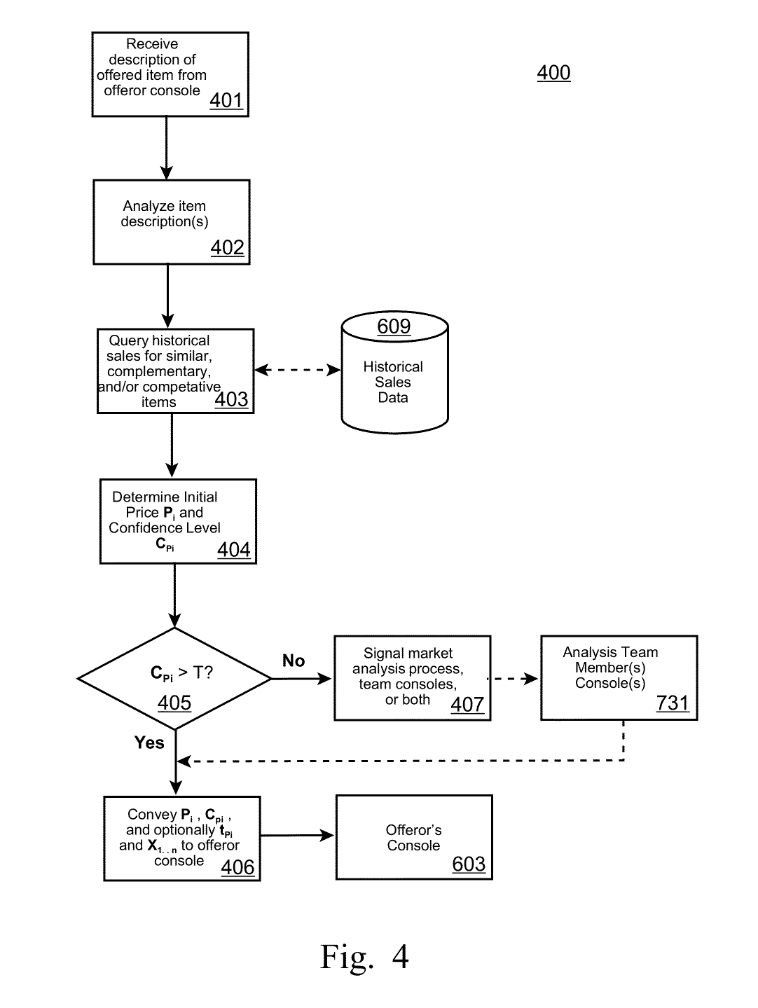

The preceding paragraphs have described aspects and components of various embodiments of the related invention. FIG. 4 sets forth a basic logical process (400) according to the related invention which highlights several notable aspects of the related inventive method:
1. A user expresses a need to determine a price for an item for sale or auction—and provides a description, which is received (401) by the APDU (702) either directly or via the auction server.
2. The APDU analyzes (402) the item description, queries (403) the historical sales (609), and determines (404) an initial price Pᵢ and confidence level C_{Pi} associated with the initial price Pᵢ.
3. If (405) the confidence level C_{Pi} is less than a threshold T, the a signal is triggered to one or more automatic market analysis services, which is at least one novel step of the present embodiments being described.
4. When the confidence level C_{Pi} is greater than (or equal to) the threshold T, the APDU conveys (406) the suggested price to the user. The system optionally suggests optimal time tp to sell the item (e.g. months, holidays, etc.) at the suggested initial price. The system also optionally suggests one or more probabilities X_{1 . . . n} of sale for different possible prices (e.g. 90% probability of sale at a price of $5000, but only 40% probability of sale at a price of $8000, etc.)

Embodiments of the related invention may also optionally perform a multi-objective optimization over time and price and present the results as a two dimensional probability distribution.

The analysis (402), querying (403) and determining (404) may be performed using a machine learning mechanism to calculate the confidence level C_{Pi}. The system may compute a ranked list of prices P_{1 . . . n}, each with a confidence value C_{1 . . . n}. An Unstructured Information Management Architecture (UIMA) may be used to facilitate the Natural Language Processing (NLP). Also, in these steps, a user-specified confidence level may be employed or considered.

In the signaling to expert analysis team(s) (704), the APDU may, in some embodiments, identify eligible market analysis services, relevant to the user's item for sale. It may rank the market analysis services in order of their likely utility in determining suggested prices for items for sale or auction, and in their likely ability for increasing the confidence level. The ranking may be determined by analyzing the quality of past contributions from market analysis services and various ratings.

The system conveyed information to the offeror's console may include a probability of sale for an item for a set of different possible prices. As an example, consider an item that has a 90% chance of sale if offered for $5000, but only a 40% chance of sale if offered at a price of $8000. This set of probabilities may be determined and provided to the seller in the form of a useful graph, pie chart, or other form. The system may estimate such probabilities [e.g. X(5000)=90% and X(8000)=40%] by, for example, analyzing previous sales or by querying experts (e.g. automatic market analysis services) in such sales. As an example, if an item sold quickly when 5 of 6 auctions offered the item (or similar item) for $5000 yet sold only one item when offered for $8000 during the past year, X(5000) would naturally be greater than X(8000).

Optional Proxy Item Probing Component

The automatic market analysis service may include initiation of an automatic, computer-controlled short-term auction in which a similar “proxy” item (or items) is offered for an abbreviated time, during which other buyers (and automatic, computer-controlled bidding elements) are able to place bids on the proxy item. The proxy item may not actually be sold during the abbreviated auction, or may be sold to an automatic bidding element and held in reserve by a third party, without demand for delivery, to be exchanged for a similar reserve items at some future date (i.e., a “market-clearing”). If in the process of performing this abbreviated auction, the item (or items) is sold to a buyer who actually demands delivery, the user of the service may be required by contract to deliver the original item at the agreed price of the proxy item. In this way, a market may be “probed” and its microstructure analyzed, potentially at a small cost or fee to the offeror, to determine the appropriate sale price of the original item. The auction and transaction costs may be then passed on to the user of the system as a fee for the service. Note that an auction service may find these various transactions to be acceptable because it receives listing fees.

Further, the element that sends a signal to a market analysis service may implement a strategy for setting the price for solicited information about an auctionable item, as well as setting a start time and deadline for soliciting and receiving information, respectively, from ranked experts. After the deadline is reached, the price may be adjusted and the deadline extended, or the offer could be withdrawn. These decisions could be based on the information collected during the market analysis service queries, or through other efforts. They could also be based on the desired confidence level and the price the user is willing to pay for a given confidence level (see elaboration of Step 4, below.) The effect of implementing this strategy is that it could improve the efficiency (i.e., cost and speed to reach certain confidence level) with which information is collected from ranked market analysis services, i.e., the experts about particular items or classes of items for sale.

### Bidder's Tool (Present Invention)

The foregoing paragraphs have described an optimization tool for use by offeror's of items into an electronic auction. The present invention, however, switches perspective to that of the bidding users (bidders), whose interests are both aligned and counter to the interests of the offeror's. For example, to the extent that both the offeror and the bidder wish to conclude a transaction to transfer ownership of an offered item from the offeror to the bidder for valuable exchange such as money or credit, both of their interests are aligned and congruent. However, to the extent that the offeror wants to sell the item at a highest possible price and the bidder wishes to pay the least amount possible, their objectives and interests are counter to each other's. Therefore, the foregoing description not only provides a technical foundation for understanding embodiments according to the present invention whereas many components and processes utilized can be re-used or in common with the embodiments of the related invention, it is also useful for understanding the motivation and benefits of the present invention when compared and contrasted to the related invention.

The inventors have realized that when an item being auctioned is rare or in low quantity of availability, the bidding by bidders may become frenzied and may reach levels which are not justified by other market conditions. For example, consider a particular bicycle which is being offered for sale, for which there is an initial quantity of 10 bicycles (identical) available. As the sixth, seventh and eighth units are sold, the bidding on the remaining units often reaches much higher levels and a much faster pace. This is due to the fact that the bidders who have not yet won the bidding on a unit become concerned they will not get one, and the evolving scarcity of the unit places psychological pressure on them to counter-bid the highest bid.

The embodiments of the present invention seeks to address this bidder behavior by allowing a proxy bidding agent to utilize statistics about the same or similar items and their previous sales, as well as concurrent information about similar or competitive items which may be available at a lower price. So, while an “unarmed” user (one without the present invention) may become absorbed in watching the progress of the frenzied bidding on the last one or two of bicycle model X, the same user may entirely miss the fact that the bidding has surpassed the current bid level on a competitive or similar bicycle model Y.

The tool, then, seeks to obtain real-time information about alternative items available, blend that with historical information about previous sales of the currently watched item, and dissuade the bidder from overbidding on an item which may not be the best alternative at the best price.

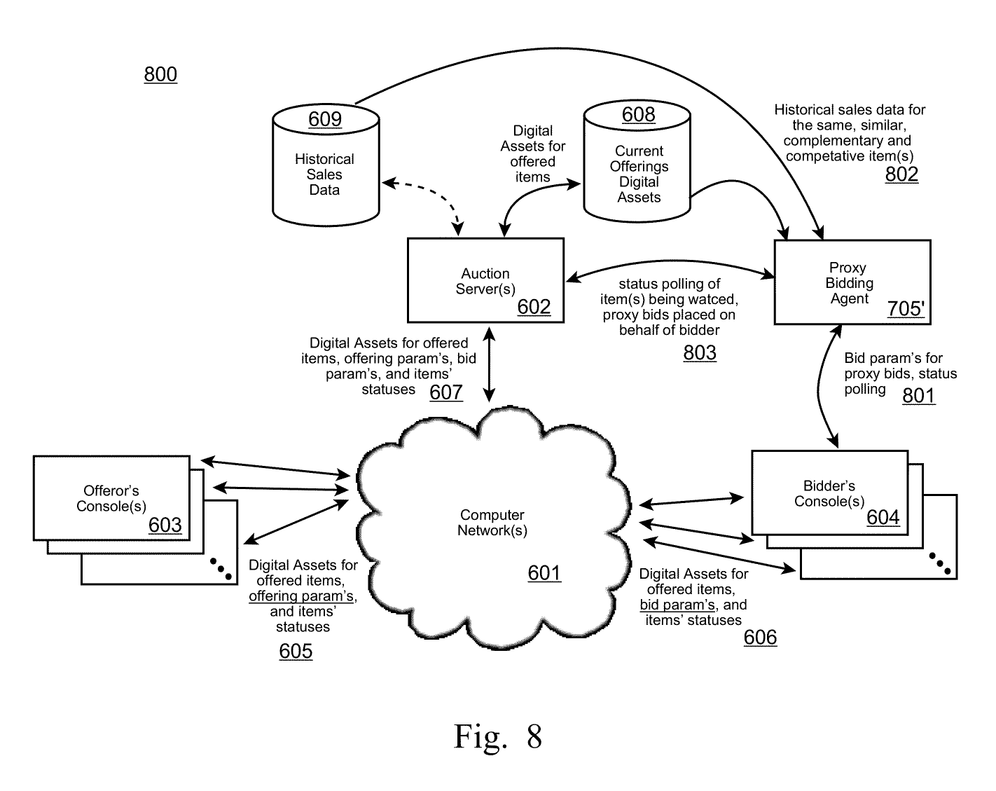

Turning to FIG. 8, a system configuration variation (800) of FIG. 2 is provided which is useful in understanding at least one embodiment according to the present invention. In the example embodiment of FIG. 2, the proxy bidding agent (705) was under the control of, and acted in the interests of, the offeror using the offeror console (603). In the present embodiment, the proxy bidding agent (705′) is re-purposed to operate on behalf of and in the interests of the bidder using the bidder console (604). Some embodiments may include multiple proxy bidding agents, some of which may operate on behalf of the offeror(s) as previously described, and some of which may operate on behalf of the bidder(s) as will be described in the following paragraphs.

In a first beneficial function of the proxy bidding agent (705′) for the bidder, the proxy bidding agent (705′) receives one or more automatic bidding control parameters (801) from the bidder via the bidder console (604). According to some embodiments of the present invention, these parameters may include:
(1) Identification of the item (e.g. the “watched item”) in the auction on which proxy bidding is to be placed, such as an auction ID or number, item number, offerror identifier, model number, serial number, etc.
(2) Identification and authorization from the bidder to place bids on behalf of the bidder, including parameters such as bidder ID, bidder username, bidder password, bidder credentials, bidder tokens, bidder account number, etc.
(3) One or more counter-bid control parameters, such as maximum bid amount, minimum amount of time between successive counter-bids, increase over current bid, etc.
(4) Counter-bid patience parameters, such as minimum number of items left for bid.

In one optional embodiment feature, the proxy bidding agent (705′) would obtain historical data (802) for the same or similar items from the auction server (or another source), and would propose or provide a default maximum bid value when quantities of the watched item reach a low threshold (e.g. a percentage of the original quantity left, a discrete value or quantity left, a maximum time to auction close left, etc.). In one embodiment, this value may be proposed to the user to advise the bidder of the historical winning bid values, but may be overridden by the user if the user wishes to go higher (or lower) in bidding.

Once enabled, the proxy bidding agent (705′) would continuously or periodically retrieve the bidding status (803) from the auction server for the watched item, and optionally for one or more alternative items. Information retrieved may include current bid level, quantity left available, time left until auction close, etc. Then, if the proxy bid restrictions are met, the proxy bidding agent (705′) would enter or place a counter-bid to top the current bid by the “increase over current bid” parameter. However, if the bid restrictions are not met, such as the quantity of available items is at or below a threshold, or the time left to close is below a threshold, or the current bid level has reached a maximum, the counter bid will not be placed.

In some embodiments, the auction server and the proxy bidding agent may be integrated or otherwise share a trusted relationship so that the proxy bidding agent may place bids on behalf of the bidder. However, in non-integrated architectures or non-trusted environments, the proxy bidding agent may receive and use the bidder's username, logon name, password, or other credential such as a digital token, to log into the auction server on behalf of the user and to place bids.

Optionally, if the bidder user attempts to manually place a new bid after the bid restrictions have been reached, the proxy bidding agent may provide a warning against such a bid.

Still further and optionally, the proxy bidding may alert the bidder user that an alternative item may currently meet the restrictions (e.g. quantity available is above the threshold, time left to close is above a threshold, and current bid level is below a threshold). And, if enabled, some embodiments may switch bidding to place counter-bids into the auction where the alternative item is being offered.

While the foregoing examples are for goods such as bicycles, the present methods are not limited to such auction environments and may be utilized with service auctions (hotel bids, airfare, communications bandwidth, electrical power, etc.) and with financial instruments (stocks, bonds, etc.). In the scenario of the latter (financial instruments), criteria such as trade volume (weekly, daily, hourly, minute-by-minute, etc.) and trade price may be considered as control parameters to avoid a bidder from becoming swept up in frenzied bidding which results in inappropriate price levels.

Suitable Computing Platform. The preceding paragraphs have set forth example logical processes according to the present invention, which, when coupled with processing hardware, embody systems according to the present invention, and which, when coupled with tangible, computer readable memory devices, embody computer program products according to the related invention.

Regarding computers for executing the logical processes set forth herein, it will be readily recognized by those skilled in the art that a variety of computers are suitable and will become suitable as memory, processing, and communications capacities of computers and portable devices increases. In such embodiments, the operative invention includes the combination of the programmable computing platform and the programs together. In other embodiments, some or all of the logical processes may be committed to dedicated or specialized electronic circuitry, such as Application Specific Integrated Circuits or programmable logic devices.

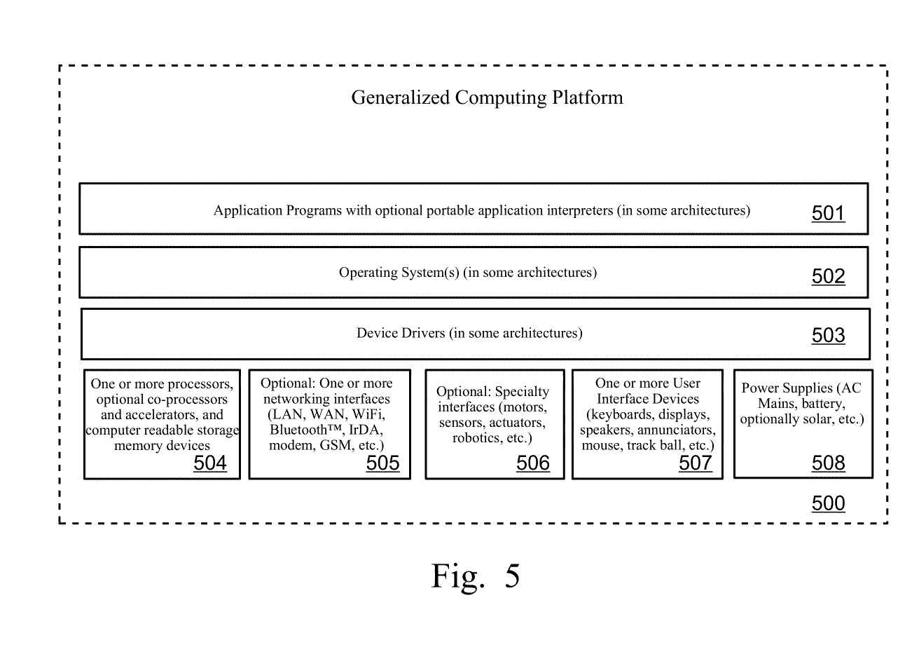

The present invention may be realized for many different processors used in many different computing platforms. FIG. 5 illustrates a generalized computing platform (500), such as common and well-known computing platforms such as “Personal Computers”, web servers such as an IBM iSeries™ server, and portable devices such as personal digital assistants and smart phones, running a popular operating systems (502) such as Microsoft™ Windows™ or IBM™ AIX™, Palm OS™, Microsoft Windows Mobile™, UNIX, LINUX, Google Android™, Apple iPhone iOS™, and others, may be employed to execute one or more application programs to accomplish the computerized methods described herein. Whereas these computing platforms and operating systems are well known an openly described in any number of textbooks, websites, and public “open” specifications and recommendations, diagrams and further details of these computing systems in general (without the customized logical processes of the present invention) are readily available to those ordinarily skilled in the art.

Many such computing platforms, but not all, allow for the addition of or installation of application programs (501) which provide specific logical functionality and which allow the computing platform to be specialized in certain manners to perform certain jobs, thus rendering the computing platform into a specialized machine. In some “closed” architectures, this functionality is provided by the manufacturer and may not be modifiable by the end-user.

The “hardware” portion of a computing platform typically includes one or more processors (504) accompanied by, sometimes, specialized co-processors or accelerators, such as graphics accelerators, and by suitable computer readable memory devices (RAM, ROM, disk drives, removable memory cards, etc.). Depending on the computing platform, one or more network interfaces (505) may be provided, as well as specialty interfaces for specific applications. If the computing platform is intended to interact with human users, it is provided with one or more user interface devices (507), such as display(s), keyboards, pointing devices, speakers, etc. And, each computing platform requires one or more power supplies (battery, AC mains, solar, etc.).

Conclusion. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It should also be recognized by those skilled in the art that certain embodiments utilizing a microprocessor executing a logical process may also be realized through customized electronic circuitry performing the same logical process(es).

It will be readily recognized by those skilled in the art that the foregoing example embodiments do not define the extent or scope of the present invention, but instead are provided as illustrations of how to make and use at least one embodiment of the invention. The following claims define the extent and scope of at least one invention disclosed herein.

What is claimed is:

1. A method for preventing or avoiding frenzied bidding in an electronic auction comprising:
receiving by a proxy bidding agent computer one or more counter-bidding control parameters from a bidder console, wherein the counter-bidding control parameters identify an item to watch, counter-bid conditions, and counter-bid patience parameters;
during an electronic auction, monitoring one or more conditions of an item in the auction while automatic counter-bidding is performed by the proxy bidding agent;
during the monitoring detecting counter-bid conditions being unmet or violated; and
responsive to the detecting, preventing counter-bidding by the proxy bidding agent.

2. The method as set forth in claim 1 wherein the an identification of an item to be watched comprises one or more parameters selected from the group consisting of an auction, an auction identifier, an auction number, an item number, an offerror identifier, an item model number, and an item serial number.

3. The method as set forth in claim 1 wherein the counter-bidding control parameters comprise one or more parameters selected from the group consisting of a bidder identifier, a bidder username, a bidder password, a bidder credential, and a bidder token and a bidder account number.

4. The method as set forth in claim 1 wherein the counter-bid conditions comprise one or more parameters selected from the group consisting of a maximum bid amount, a minimum amount of time between successive counter-bids, an increase over current bid value.

5. The method as set forth in claim 1 wherein the counter-bid patience parameters comprise one or more conditions selected from the group consisting of a minimum number of items left for bid, a percentage of an original quantity of available items, a minimum time left until an auction close time, and a disablement in favor of an alternative available item.

6. The method as set forth in claim 1 further comprising:
receiving by the proxy bidding agent historical data for the item to be watched or for one or more items indicated as being similar to the item to be watched;
determining by the proxy bidding agent a historical value for one or more control parameters selected from the group consisting of a historical winning bid for the item or similar item according to the historical data, a low quantity available threshold beyond which frenzied bidding has historically occurred, and a minimum time left until closing of an auction after which frenzied bidding has historically occurred; and
proposing the one or more historically-based control parameters to a user to seed the automatic bidding.

7. The method as set forth in claim 6 further comprising:
monitoring by the proxy bidding agent manual attempts to entered counter-bids from a bidder's console; and
responsive to detecting an attempt to manually counter-bid when one or more counter-bidding conditions have been met or violated, alerting by the proxy bidding agent the user to a possible overbidding attempt.

8. The method as set forth in claim 1 further comprising:
further monitoring by the proxy bidding agent of auction conditions of one or more available items which were indicated as being the same or similar to the watched item; and
responsive to a counter-bid condition being met or violated, alerting by the bidding proxy agent a user via a bidder console of the alternative item's availability at acceptable conditions.

9. The method as set forth in claim 1 further comprising:
further monitoring by the proxy bidding agent of auction conditions of one or more available items which were indicated as similar to the watched item; and
responsive to a switch-over condition being detected, automatically counter-bidding on the similar item while preventing further counter-bidding on the watched item, wherein the switch-over condition comprises a condition selected from the group consisting of a patience condition, a counter-bid condition, a bid level for the watched item exceeding a bid level for the similar item, a quantity-left-available for the watched item being exceeded by a quantity-left-available for the similar item, and a time-left-to-close for the watched item being exceeded by a time-left-to-close for the similar item.

10. A computer program product for preventing or avoiding frenzied bidding in an electronic auction comprising:
one or more tangible, computer readable storage memory devices;
first program code for receiving by a proxy bidding agent computer one or more counter-bidding control parameters from a bidder console, wherein the counter-bidding control parameters identify an item to watch, counter-bid conditions, and counter-bid patience parameters;
second program code for, during an electronic auction, monitoring one or more conditions of an item in the auction while automatic counter-bidding is performed by the proxy bidding agent;
third program code for, during the monitoring detecting counter-bid conditions being unmet or violated; and
fourth program code for, responsive to the detecting, preventing counter-bidding by the proxy bidding agent;
wherein the first, second, third and fourth program codes are stored by the one or more tangible, computer readable storage memory devices.

11. The computer program product as set forth in claim 10 wherein the counter-bid conditions comprise one or more parameters selected from the group consisting of a maximum bid amount, a minimum amount of time between successive counter-bids, an increase over current bid value.

12. The computer program product as set forth in claim 10 wherein the counter-bid patience parameters comprise one or more conditions selected from the group consisting of a minimum number of items left for bid, a percentage of an original quantity of available items, a minimum time left until an auction close time, and a disablement in favor of an alternative available item.

13. The computer program product as set forth in claim 10 further comprising:
fifth program code for receiving by the proxy bidding agent historical data for the item to be watched or for one or more items indicated as being similar to the item to be watched;
sixth program code for determining by the proxy bidding agent a historical value for one or more control parameters selected from the group consisting of a historical winning bid for the item or similar item according to the historical data, a low quantity available threshold beyond which frenzied bidding has historically occurred, and a minimum time left until closing of an auction after which frenzied bidding has historically occurred; and
seventh program code for proposing the one or more historically-based control parameters to a user to seed the automatic bidding;
wherein the fifth, sixth and seventh program codes are stored by the one or more tangible, computer readable storage memory devices.

14. The computer program product as set forth in claim 13 further comprising:
eighth program code for monitoring by the proxy bidding agent manual attempts to entered counter-bids from a bidder's console; and
ninth program code for, responsive to detecting an attempt to manually counter-bid when one or more counter-bidding conditions have been met or violated, alerting by the proxy bidding agent the user to a possible overbidding attempt;
wherein the eighth and ninth program codes are stored by the one or more tangible, computer readable storage memory devices.

15. The computer program product as set forth in claim 10 further comprising:
fifth program code for further monitoring by the proxy bidding agent of auction conditions of one or more available items which were indicated as being the same or similar to the watched item; and
sixth program code for, responsive to a counter-bid condition being met or violated, alerting by the bidding proxy agent a user via a bidder console of the alternative item's availability at acceptable conditions;
wherein the fifth and sixth program codes are stored by the one or more tangible, computer readable storage memory devices.

16. A system for preventing or avoiding frenzied bidding in an electronic auction comprising:
a proxy bidding agent computer having an electronic circuit for performing logical processes;
a parameter input portion of the proxy bidding agent computer for receiving one or more counter-bidding control parameters from a bidder console, wherein the counter-bidding control parameters identify an item to watch, counter-bid conditions, and counter-bid patience parameters;
a condition monitor portion of the proxy bidding agent for, during an electronic auction, monitoring one or more conditions of an item in the auction while automatic counter-bidding is performed by the proxy bidding agent;
a counter bid monitor of the proxy bidding agent for, during the monitoring detecting counter-bid conditions being unmet or violated; and
a counter-bid preventer of the proxy bidding agent for, responsive to the detecting, preventing counter-bidding by the proxy bidding agent.

17. The system as set forth in claim 16 wherein the counter-bid conditions comprise one or more parameters selected from the group consisting of a maximum bid amount, a minimum amount of time between successive counter-bids, an increase over current bid value.

18. The system as set forth in claim 16 wherein the counter-bid patience parameters comprise one or more conditions selected from the group consisting of a minimum number of items left for bid, a percentage of an original quantity of available items, a minimum time left until an auction close time, and a disablement in favor of an alternative available item.

19. The system as set forth in claim 16 further comprising:
a historical data input of the proxy bidding agent for receiving by the proxy bidding agent historical data for the item to be watched or for one or more items indicated as being similar to the item to be watched;
a historical value analyzer of the proxy bidding agent for determining by the proxy bidding agent a historical value for one or more control parameters selected from the group consisting of a historical winning bid for the item or similar item according to the historical data, a low quantity available threshold beyond which frenzied bidding has historically occurred, and a minimum time left until closing of an auction after which frenzied bidding has historically occurred; and
a seed bid proposer of the proxy bidding agent for proposing the one or more historically-based control parameters to a user to seed the automatic bidding.

20. The system as set forth in claim 16 further comprising a manual attempt monitor of the proxy bidding agent for monitoring by the proxy bidding agent manual attempts to entered counter-bids from a bidder's console, and for, responsive to detecting an attempt to manually counter-bid when one or more counter-bidding conditions have been met or violated, alerting by the proxy bidding agent the user to a possible overbidding attempt.
